(19) United States
(12) Patent Application Publication
(10) Pub. No.: US 2018/0246261 A1
(43) Pub. Date: Aug. 30, 2018

(54) REFLECTIVE COMPOSITE MATERIAL COMPRISING AN ALUMINUM SUBSTRATE AND A SILVER REFLECTIVE LAYER

(71) Applicant: ALANOD GMBH & CO. KG, ENNEPETAL (DE)

(72) Inventors: FRANK TEMPLIN, HERDECKE (DE); STEFAN ZIEGLER, SPROCKHÖVEL (DE); TOBIAS TITZ, HAAN (DE); MICHAEL AUSTGEN, VELBERT (DE); DIMITRIOS PEROS, SIEGEN (DE)

(73) Assignee: ALANOD GMBH & CO. KG, ENNEPETAL (DE)

(21) Appl. No.: 15/754,142

(22) PCT Filed: Aug. 24, 2016
(86) PCT No.: PCT/EP2016/069990

§ 371 Date: Feb. 21, 2018

(30) Foreign Application Priority Data
Aug. 25, 2015 (DE) 10 2015 114 095.0

(51) Int. Cl. G02B 5/08

(52) U.S. Cl. CPC G02B 5/0858; C25D 11/18

(57) ABSTRACT

The invention relates to a reflective composite material (V) with a substrate (1) consisting of aluminum, with an intermediate layer (2) of anodic oxidized substrate material located on one side (A) of the substrate (1), and with an optically active multi-layer system (3) applied above the intermediate layer (2), wherein the multi-layer system consists of at least three layers, and wherein the upper layers (4, 5) are dielectric and/or oxidic layers, and the bottom layer (6) is a metallic layer consisting of silver which forms a reflective layer (6). To increase the ageing resistance the invention proposes that a diffusion-inhibiting barrier layer (8) is disposed above the intermediate layer (2) and below the reflective layer (6), wherein the reflective layer (6) is bonded to the barrier layer (8) by an adhesion-promoting layer (9).

### CROSS-REFERENCE TO RELATED APPLICATIONS

This application is 35 U.S.C. § 371 national phase application of PCT International Application No. PCT/EP2016/069990, filed Aug. 24, 2016, which claims the benefit of priority under 35 U.S.C. § 119 to German Patent Application No. 10 2015 114 095.0, filed Aug. 25, 2015, the contents of which are incorporated herein by reference in their entirety.

### FIELD OF THE INVENTION

The present invention relates to a reflective composite material with a substrate consisting of aluminum, with an intermediate layer of anodic oxidized substrate material located on one side of the substrate, and with an optically active multi-layer system applied above the intermediate layer, wherein the multi-layer system consists of at least three layers, wherein the upper layers are dielectric and/or oxidic layers, and the bottom layer is a metallic layer consisting of silver which forms a reflective layer.

### BACKGROUND

A composite material of the above generally described kind as a surface-enhanced aluminum band known under the tradename MIRO®-Silver has enjoyed widespread use in lighting systems, daylight systems and decorative applications. The surface treatment is used to better protect the sensitive aluminum surface and to increase the light reflectivity. The surface enhancement process consists of two different processes, which can both be operated continuously, and specifically consists of the production of the intermediate layer in a wet-chemical process, which is known generically as anodizing, and includes an electrolytic luster process and also an anodic oxidation, and of the application of the optically active multi-layer optical system in a vacuum.

As the substrate material for reflectors with a high total reflectivity, rolled aluminum with a minimum purity of 99.8% is used, and since raw aluminum has a sensitive surface, the intermediate layer has to be applied so as to protect against mechanical and chemical influences in order to attain the useful properties. This protective intermediate layer is produced in the wet-chemical anodizing process, wherein the result attained is that the surface features a sufficiently low roughness and a sufficient hardness and also a defect-free formation. Due to a change in the purity and/or the roughness, the level of total reflection can be varied, whereas by specific changes to the rolled structure of the aluminum substrate the degree of diffuse reflection can also be varied. A highly reflective purest silver layer is deposited onto the anodized layer. It is optically dense and has an extremely high total reflection in the visible range of light.

There are usually at least two layers of the multi-layer optical system located on the silver layer; in general these pertain to dielectric layers, wherein the use of oxidic layers, such as aluminum oxide or titanium oxide, for example, as highly refractive top layer and silicon dioxide as the lower refractive layer underneath and deposited onto the silver layer, represents a special, preferred case. Details thereof are found, for example, in the description of the known MIRO® process, which however, does use aluminum as metallic reflective layer; see “elektrowärme international” 53 (1995) B 4—November, pp. B215-B223.

In general, when radiation strikes an object, this radiation is split into a reflected, an absorbed and a transmitted component, which are determined by the reflectivity (reflective capacity), the absorptivity (absorption capacity) and the transmissivity (transmission capacity) of the object. Reflective capacity, absorption capacity and transmission capacity are optical properties which can take on different values for one and the same material, depending on the wavelength of the incident radiation (e.g. in the ultraviolet range, in the range of visible light, in the infrared range and in the range of thermal radiation). With respect to the absorptive capacity, the known Kirchhoff law describes how the degree of absorption is in a constant ratio to the degree of emission at a particular temperature and wavelength. Thus, for the absorption capacity, the Wien's displacement law or Planck's law and also the Stefan-Boltzmann law are relevant; they describe the particular relationships between radiation intensity, spectral distribution density, wavelength and temperature for a so-called “black body.” In this regard it must be taken into account in any calculations that the “black body” does not exist per se, and each real material will deviate in some characteristic manner from the ideal distribution.

In the known composite material, the high reflective capacity in the range of visible light plays a particularly important role, which is expressed for example, in a total light reflectivity with peak values of up to more than 98 percent determined according to DIN 5036, Part 3. In addition, for the known material, which is supplied preferably as a semi-finished product, its outstanding processability, in particular its deformability, must be emphasized. However, the problem with Miro®-Silver material, especially in long-term applications and when used in a hot environment, such as in hot climates or together with a light source which features a powerful heat radiation, is that there can be a faster loss of reflective capacity than for the already long-known Miro®-material whose reflective metallic layer consists of aluminum. Due to the mentioned material difference, the reason for this phenomenon is viewed as being a corrosion of the silver associated with diffusion processes. It is to be assumed here that an electrochemical difference in potential between the less noble aluminum substrate and the silver reflective layer, which as a noble metal has a greater standard potential in the electrochemical series, is viewed as promoting the diffusion.

The object of the present invention is to create a composite material of the kind described above, with high reflectivity and therefore one that is particularly suitable for reflective systems, which features reduced loss of total light reflectivity in the long term, especially at temperatures greater than room temperature (20° C.), and which features a high mechanical resistance of the surface, i.e. in particular an abrasion-resistant surface.

### SUMMARY AND INTRODUCTORY DESCRIPTION OF THE INVENTION

The above-described object is inventively achieved for the composite material by a diffusion-inhibiting barrier layer being disposed above the intermediate layer and below the reflective layer, wherein the reflective layer is bonded to the barrier layer via an adhesion-promoting layer.

Due to the barrier layer a migration of silver particles; in particular a migration of silver ions is assumed; through any still possibly present pores in the anodic oxidized layer located below the silver layer is advantageously prevented and/or at least substantially avoided. Thus no local element acting as a corrosion-promoter can arise between the silver layer and the aluminum substrate, so that the degree of total light reflectivity remains stable for the long term.

In particular, the barrier layer can be a metallic or nitride layer which preferably contains metallic chromium or nickel, and when the barrier layer consists of metal, in particular chromium, the reflective effect of the layer system can be increased even more. Palladium is also indicated as one possible layer constituent of the barrier layer.

Generally stated, the barrier layer can advantageously contain a material of the chemical composition CrwNixNyOz, wherein the indices w, x, y and z denote a stoichiometric or non-stoichiometric ratio, which can preferably be defined as follows: 0≤w≤1 and 0≤x≤1, wherein at least one of the indices w or x is greater than zero, 0≤y≤1, 0≤z≤5. In this formula, chromium (x, y, z=0), nickel (w, y, z=0), intermetallic chromium-nickel compounds (y, z=0) and also chromium- and/or nickel nitride (z=0), −oxidic (y=0) and/or oxi-nitride compounds are covered. If the index x=0, then it is preferably a nickel-free layer, that is, a layer with no heavy metal.

By means of the invention, a layer structure is produced in a favorable manner in which the diffusion path of the silver upon the aluminum substrate is additionally shifted. In this regard the barrier layer can have a thickness; in particular in the case of a metallic chromium layer; in the range from 50 nm to 150 nm. However, in general the thickness of the barrier layer can be in the range from 5 nm to 500 nm, wherein a range from 10 nm to 200 nm is preferred, and a range from 15 nm to 70 nm is particularly preferred.

According to Fick's first law of diffusion, the density of particle flow (flux) J (mol m⁻² s⁻¹) is proportional to the concentration gradient (propulsive force) ∂c/∂x (mol·m⁻⁴) against the direction of diffusion. The proportionality constant is the diffusion coefficient D (m²s⁻¹)

$$J = - D \frac{\partial c}{\partial x}$$

Therefore the diffusion coefficient is a measure of the mobility of the particles and can be determined from the average square of the path traversed per time unit. In the case of diffusion in solid bodies, jumps are required between different lattice sites. In this case, the particles must overcome an energy barrier E which is more easily achieved at higher temperature than at lower temperature. This is described by the relation:

$$D = {D}_{0} \cdot exp ( - \frac{E}{R \cdot T} )$$

with
E—Energy barrier (in J·mol⁻¹)
R—general gas constant (in J·K⁻¹ mol⁻¹)

### T—Temperature (in K).

The diffusion coefficient of the silver is reduced by the barrier layer. The reduction in the diffusion coefficient is attributable to the fact that the energy barrier E, which must be overcome by the silver particles in the barrier layer to switch between different lattice sites, is greater than the energy barrier E in the anodically oxidized layer. Downward migration of a particle; toward the substrate; through pores in the anodic oxidized layer located under the silver layer, or through the aluminum oxide of the layer itself, is thus inhibited in the sense of the first law of diffusion. A temperature elevated in particular with respect to room temperature, under consideration of the aging occurring under the relation stated above, which is expressed in a decrease in the total light reflective, is thus exceptionally retarded, with the attendant advantages.

The anodically oxidized layer; even if it is not located at the surface; together with the barrier layer, the adhesion-promoting layer and the optical multi-layer system, are of great importance for establishing a high scratch and wipe resistance, and also for the corrosion resistance of the composite material according to the invention.

Pores in the aluminum oxide layer in the wet chemical process chain can be mostly sealed by a hot sealing occurring with steam, so that a persistent, tough surface is produced on the substrate. This acts additionally as a diffusion inhibitor. Due to the aluminum substrate, and also for the anodized layer whose thickness can be, in particular in the range from 0.01 μm to 10.0 μm, preferably in the range from 0.5 μm to 2.0 μm, more preferably in the range from 0.7 μm to 1.5 μm; an excellent deformability is assured, so that the composite material according to the invention resists with no difficulty the stresses occurring during any subsequent shaping processes. Additional advantages to be emphasized are the high thermal conductance of the substrate and its ability to follow the relief of a surface structure which promotes the reflection in the solar wavelength range, or to follow a variable surface structure according to the proportions of diffuse and directed reflection.

The composite material according to the invention can be produced as a coil; in particular with a width of up to 1400 mm, preferably up to 1600 mm. A reflector material of this kind made of aluminum band according to the invention is deformable, without the optical, mechanical and chemical properties of the material being adversely impacted.

In order to improve the adhesion in the production of the composite material onto the silver layer to be deposited onto the barrier layer, in particular onto chromium, an adhesion-promoting layer is provided. In this case an oxidic adhesion promoter, such as preferably Al₂O₃, TiO₂ or CrOₛ are employed, since they display a low reactivity with respect to the silver, and wherein s in turn denotes a stoichiometric or non-stoichiometric relationship. The layer thickness of the adhesion-promoting layer in this case can be in a range from 1 nm to 50 nm, preferably in the range from 5 nm to 25 nm, and particularly preferred in the range of 10 nm to 20 nm.

The thickness of the reflective layer can be in the range of 30 nm to 200 nm. With reference to the physical relationships stated above, this will ensure a low transmission and high reflection of the electromagnetic radiation. The silver layer can also be made from partial layers, as also can all other described layers. As the preferred thickness of the silver layer, it is preferable to select a thickness in the range of 40 nm to 150 nm, and quite particularly a thickness in the range of 50 nm to 100 nm.

The adhesion-promoting layer and also the layers of the optical multi-layer system can be sputter layers, produced in particular by reactive sputtering, CVD (chemical vapor deposition) or PE-CVD (plasma enhanced chemical vapor deposition) layers, or layers created by vapor deposition, in particular by electron bombardment or layers produced from thermal sources, so that the entire multiple-layer system located on the intermediate layer is created in an optimum manner from the processing point of view, using layers applied in a vacuum sequence, in particular in a continuous process. The named methods make it possible, in a favorable manner, to vary the chemical composition of the layers with respect to the indices w, x, y and z, and to adjust them not only to certain, discrete values, but also to vary the stoichiometric or non-stoichiometric ratio of the layer-forming elements to each other within certain limits.

In this manner, for example, the particular refractive indices of the two upper layers, which cause an increase in the reflection due to their pairing, can be adjusted specifically when the top layer has a higher refractive index than the layer located underneath. The material of the two layers located above the silver layer can belong to the group of metal oxides, fluorides, nitrides or sulfides, or mixtures thereof, wherein the layers display different refractive indices. For example, a difference in the refractive indices; relative to a wavelength of 550 nm; can be greater than 0.10, preferably greater than 0.20, for instance. As materials for the top, highly refractive layer, compounds such as Ta2O5, Nb2O5, MoO3, TiO₂ and ZrO2 can be used, and materials to be used for the low-refractive index layer can be Al₂O₃ and SiO₂.

With regard to the index of the oxygen in the above-stated oxides, in particular with regard to the index “2” in the TiO₂, it should be noted that the oxidic layers need not necessarily be entirely stoichiometric, but rather could also be present as another oxide or suboxide, as long as they still have nearly the same high light transparency as the stoichiometric structured oxides.

The particular optical density of the upper and of the middle layer of the optical layer system should preferably be selected; in order that the layers can act as reflection-increasing interference layers; so that it amounts to about one-quarter of the middle wavelength of the spectral range of the electromagnetic radiation to be reflected.

The upper, highly refractive dielectric layer can have a thickness, in particular in the range of 30 nm to 200 mm, preferably of 40 nm to 100 nm, most preferably in the range of 45 nm to 65 nm.

The lower refractive, dielectric layer located underneath can have a thickness in particular in the range of 30 nm to 200 nm, preferably in the range of 40 nm to 100 nm, and most preferably in the range of 50 nm to 70 nm.

To improve the adhesion onto the silver layer and/or to prevent a delamination of the low-refractive layer from the silver layer, an additional adhesion promoting layer can be provided which likewise is in particular oxidic and can consist preferably of CrOₛ. In principle, the second adhesion-promoting layer herein can have a thickness which resides in the same range as that of the first adhesion-promoting layer. However, typically it should have the smallest possible thickness so that while attaining a satisfactory adhesion, the layer itself will cause only a very minor absorption.

As an additional, fourth layer, another, in particular silicon oxide and/or nitride covering layer can be placed over the highly refractive, upper layer of the optical multi-layer system. This fourth layer displays a high transmission capacity and improves the mechanical and corrosion resistance. An outstanding adhesion is to be obtained when a dielectric layer located directly underneath the covering layer is a Nb₂O₅ and Ta2O5 layer applied in a PVD (physical vapor deposition) method, wherein this also promotes a good hardness and elasticity of the invented composite material. Alternatively, a titanium dioxide layer is recommended. The covering layer of the optical multi-layer system herein can have a minimum thickness of 3 nm, for example. In particular, from a thickness of 5 nm to 20 mn, the layer already possesses a sufficient effectiveness of its protective effect, wherein the time, material and energy expense take on very small values. An upper limit to the layer thickness under these considerations is at about 500 nm.

Additional favorable embodiments of the invention described in the following detailed description.

### BRIEF DESCRIPTION OF THE DRAWINGS

The invention will be explained in greater detail using an exemplary embodiment illustrated by the accompanying drawings. The figures show:

FIG. 1 is a fundamental cross-sectional depiction through a composite material according to the invention, wherein the layer thicknesses contained therein are purely schematic and are not illustrated true to scale;

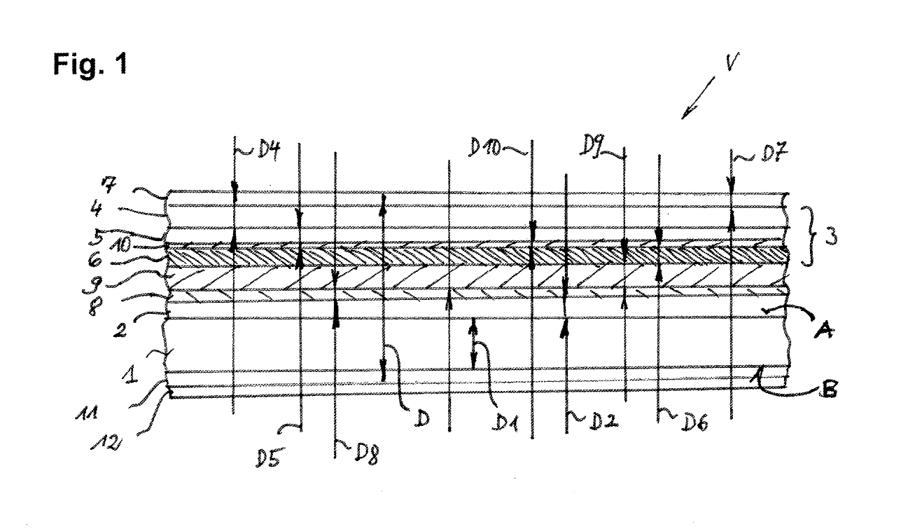

FIG. 2 is a comparative, diagrammatic representation of the reflectivity over a test period for samples of composite material according to the invention and for samples not according to the invention.

### DETAILED DESCRIPTION

The described design relates to a composite material V according to the invention with a high degree of reflectivity, in particular in the solar wavelength range. It can be used preferably for reflecting of optical radiation; that is, electromagnetic radiation in the wavelength range of 100 nm up to 1 mm.

The composite material V consists of a band-like; especially a deformable; substrate 1 of aluminum, an intermediate layer 2 located on one side A of the substrate 1, and an optically active multi-layer system 3 applied onto the intermediate layer 2.

A total light reflectivity determined according to DIN 5036, part 3, amounts to more than 95% on side A of the optical multi-layer system 3, preferably at least 97%, most preferably at least 98%.

The composite material V can be produced preferably as a coil with a width up to 1600 mm, preferably of 1400 mm, and; including any possible provided layers on its back side B; formed with a thickness D of approximately 0.2 mm to 1.7 mm, preferably of approximately 0.3 to 0.8 mm, most preferably 0.4 mm to 0.7 mm. The substrate 1 alone can have preferably a thickness D1 in the range of 0.2 mm to 0.6 mm

The aluminum of the substrate 1 can have in particular a greater purity than 99.0%, so that its thermal conductivity is promoted. Thus the generation of thermal peaks is prevented and then the coefficient of diffusion can be kept small. For example, the substrate 1, but also the band-like aluminum sheet metal can be Al 98.3 (purity 98.3 percent) with a thickness D1 of 0.5 mm. The minimum thickness D1 of one such sheet metal can be 100 μm, whereas the upper limit of thickness D1 can be at approximately 1.5 mm. It is also possible to use aluminum alloys as substrate 1, such as AlMg-alloys for example, provided they can be used to form the intermediate layer 2 by means of anodic oxidation.

The intermediate layer 2 consists of anodically oxidized aluminum which is formed from the substrate material, and can have a thickness D2 in the range of 10 nm to 10.0 μm, preferably in the range of 500 nm up to 2.0 μm, most preferably in the range of 700 nm to 1.5 μm. It can be prepared by wet-chemical process wherein the pores of the aluminum oxide layer in the final phase of the process chain can be mostly sealed by a hot-sealing.

In this case it is preferable that the surface of the intermediate layer 2 have an arithmetic average roughness value Rₐ in the range of less than 0.05 μm, in particular of less than 0.01 μm, most preferably of less than 0.005 μm. When the above-mentioned high total light reflectivity is present, this average roughness will aid in adjusting of a minimum diffuse light reflectivity defined according to DIN 5036. If a higher diffuse light reflectivity is required, then the roughness can be increased accordingly.

The optical multi-layer system 3 embodiment described includes at least three layers 4, 5, 6, wherein the upper layers 4, 5 are dielectric and/or oxidic layers, and the lowest layer (bottom layer) 6 is a metallic layer consisting of silver, which forms a reflective layer 6. The particular optical thickness D4, D5 of the upper and of the upper layers 4, 5 of the optical layer system 3 should be dimensioned; in order that the layers 4, 5 can act as reflection-elevating interference layers; so that they are approximately one-fourth of the average wavelength of the spectral range of the electromagnetic radiation to be reflected. The thickness D6 of the reflective layer 6 can be preferably in the range of 40 nm to 150 nm.

In the illustrated embodiment, an optionally provided silicon oxidic covering layer 7 with a thickness D7 is applied onto the upper layer 4 of the optical multi-layer system 3. It is also possible to apply a silicon nitride or silicon oxide-nitride layer 7 onto the optical multi-layer system 3. The optical multi-layer system 3; including the covering layer 7; can be applied in a technologically favorable manner by use of a continuous vacuum band-coating process.

Likewise, the optionally provided covering layer 7 can pertain to a mixed layer having the chemical composition SiₐC_{b}O_{c}N_{d}Hₑ, wherein the indices a, b, c, d and e denote a stoichiometric or non-stoichiometric ratio, and are adjusted such that the covering layer 7 at a selected layer thickness D7 has only a small light absorption, in particular a light absorption of less than 10 percent, preferably of less than 5 percent, and most preferably of less than 1 percent, and wherein the carbon content; relative to the total mass of the covering layer 7; is in the range of 0 atom-percent, in particular of 0.2 atom-percent, up to 15.0 atom-percent, preferably in the range of 0.8 atom-percent to 4.0 atom-percent. For an index a=1, the other indices can fall in the following ranges: 0≤b≤2, 0≤c≤2, 0≤d≤4/3, 0≤e≤1. At least one of the indices b, c and d in this case should be different from zero.

A layer of this kind can be applied in particular as a CVD-layer, preferably as a PE-CVD layer, wherein the advantage of its use consists in that it has a barrier effect against corrosive media, wherein especially due to a fraction of carbon, a greater flexibility and toughness of the layer can be adjusted than for purely ceramic SiO₂ layers.

Finally, a silicon-organic lacquer layer based on a sol-gel layer, in particular with a preferred layer thickness in the range of 0.5 μm to 5 μm, can be applied onto the optical multi-layer optical system 3 as covering layer 7.

In order to achieve a reduced loss of total light reflectivity over long-term use of the invented composite material and/or at elevated temperature, that is, in order to retard the ageing process, according to the invention a diffusion-inhibiting barrier layer 8 is arranged over the intermediate layer 2 and under the reflective layer 6. The reflective layer 6 is bonded to the barrier layer 8 using an adhesion-promoting layer 9. As already mentioned, the barrier layer 8 can be a metallic or nitridic layer, wherein especially metallic chromium is viewed as being preferred.

Expressed in general terms, it is an advantage that the barrier layer 8 can contain, or can be composed entirely of a material with the chemical formula Cr_{w}NiₓN_{y}O_{z}. The indices w, x, y and z therein denote a stoichiometric or non-stoichiometric ratio which is defined as follows: 0≤w≤1 and 0≤x≤1, wherein at least one of the indices w or x is greater than zero, 0≤y≤1, z≤5. The barrier layer 8 can have preferably a thickness D8 in the range from 10 nm to 200 nm. In the case of a chromium nitride layer, a minimal thickness D8 can be in particular at 40 nm. The coefficient of diffusion of the diffusing silver in the barrier layer 8 is greatly reduced in comparison to the diffusion into aluminum oxide.

The adhesion-promoting layer 9 is provided to increase the adhesion of the reflective layer 6 made of silver, onto the barrier layer 8. Suitable layer materials herein are in particular, oxidic adhesion promoting agents, such as preferably Al₂O₃, TiO₂ or CrOₛ, wherein s denotes a stoichiometric or non-stoichiometric ratio and should be in the range of 0<s<1.5. The layer thickness D9 of the adhesion-promoting layer herein can be in the range of 1 nm to 50 nm, preferably in the range of 5 nm to 25 nm. A range of between 10 nm to 20 nm is viewed as being particularly preferred.

To improve the adhesion and prevent any delamination of the lower refractive layer 5 to or from the silver layer 6, an additional adhesion-promoting layer 10 can be provided; as illustrated; which is likewise in particular oxidic and can consist of CrOₛ. The second adhesion-promoting layer 10, which is associated with the optical multi-layer system 3 due to its position, can have a thickness D10 here which falls in the range from 0.1 to 10 nm, preferably in the range from 0.5 to 5 nm. A light-absorptive effect is known for the chrome-oxidic, in particular the sub-stoichiometric CrOₛ-compounds compared to tri-valent chromium. However, this effect reduces the high, total light reflectivity only marginally, especially when thickness D10 is in the preferred range.

The adhesion-promoting layers 9, 10; like the layers 4, 5 and 6 of the optical multi-layer system; can be sputter layers, in particular layers produced by reactive sputtering, CVD or PE-CVD layers or layers produced by vapor coating, especially by electron bombardment or generated from thermal sources, so that the entire multi-layer optical system present on the intermediate layer consists of layers applied in a vacuum sequence, in particular in a continuous process.

All layers of the invented composite material V, and also the good adhesion between them contribute to a high scratch resistance. In particular, in a synergistic cooperation, both the comparatively thicker and harder anodized layer 2, and also the comparatively thinner and less hard dielectric layers located thereon, all make a contribution. This is expressed, for example, in a high wipe resistance, which can be determined in a wipe test according to the currently applicable standard DIN ISO 9211-4:2012, which has replaced the former DIN 58196. The following degrees of severity listed below are taken from Table 1 of the referenced standard.

TABLE 1
Degrees of severity for stress type 01: Abrasion

| | Degree of severity | | | |
|---|---|---|---|---|
| | 01 | 02 | 03 | 04 |
| Abrader | Cheesecloth | Cheesecloth | Eraser | Eraser |
| Number of | 50 | 100 | 20 | 40 |
| strokes | | | | |
| Force | 5 N ± 1 N | 5 N ± 1 N | 10 N ± 1 N | 10 N ± 1 N |

In contrast to the usage in this table, the composite material V according to an embodiment of the invention (without the optional covering layer 7) was tested with a felt cloth instead of a cheesecloth. After 100 strokes with a felt surface, no damage to the surface was visible.

In general, when no date is provided for the cited standards, the applicable versions are those in effect on the date of the subject patent application.

The improvement in properties attainable by the invention is expressed in that after at least 168 h of exposure at elevated temperature (≥50° C.), no optical change to the surface and/or a decrease in total light reflective of less than 1% (for LED applications per DIN 5036-3) and/or a decrease in the solar weighted total reflection of less than 1 (for solar applications with a solar spectrum AM1.5 from ASTM G173-03) occurred, after the composite material according to the invention had been exposed to a UV-B radiation corresponding to standard DIN ISO 9211-4:2006 in combination with a controlled condensation. The same applies for a test under the presently applicable version of the American Standard Test Method ASTM D4585 “Testing Moisture Resistance of Coatings with Controlled Condensation”, wherein the invented composite material was exposed to a controlled condensation without irradiation under the conditions specified by the standard. These values were not attained by the known material described above which is not in accordance with the invention.

In the following comparison of conventional and invention-based examples, a solar simulator as per ASTM E-927-85 “Standard Specification for Solar Simulation for Terrestrial Photovoltaic Testing”, “Type Class A” was used, with a measured UV-A and UV-B total intensity on the sample surface in the range of 70 mW/cm² to 150 mW/cm². The samples were consistently temperature-controlled in that the measured temperature at the surface of the sample was always in a range of ≥150° C. The particular sample tested was considered to have passed the test when the decrease in total light reflection Y (D65) was less than 1% (for LED applications as per DIN 5036-3), or when the decrease in the total solar weighted reflection Rₛₒₗₐᵣ was less than 1% (for solar applications with the solar spectrum AM1.5 from ASTM G173-03). Since in both cases we are dealing with reflection quantities stated in percentages, the reference symbol ΔR is used consistently for the decrease in the particular parameter. For a change in reflection ΔR not exceeding this amount, a positive test will be based on an exposure time of at least 500 h at a total UV intensity of 150 mW/cm², whereas for a positive test at a total UV intensity of 70 mW/cm², the exposure time must be at least 1000 h.

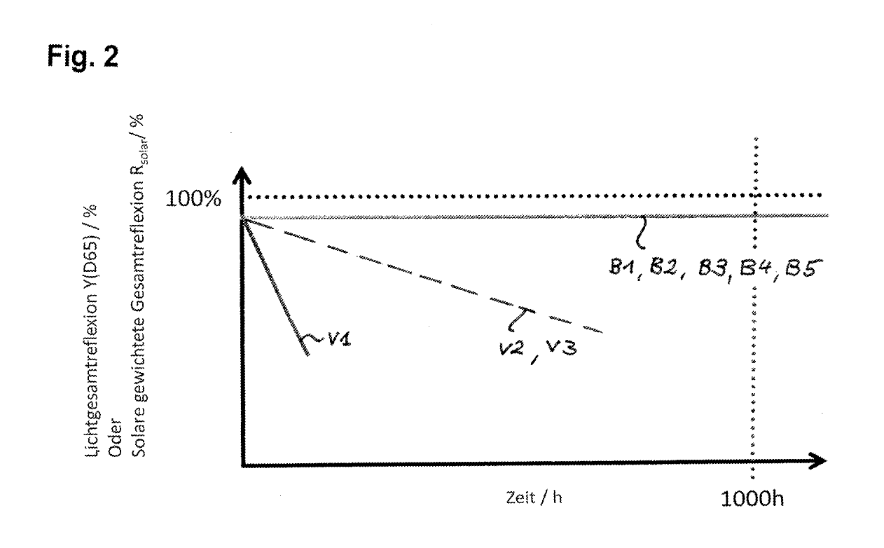

The layer thicknesses in the following comparison examples and invention examples represented in FIG. 2 were each in the preferred, or if stated, the especially preferred, ranges provided above.

### Comparison Example 1 (Reference Symbol V1 in FIG. 2)

Layer system (from bottom to top):

Substrate 1: Aluminum

Intermediate layer 2: Anodized aluminum

Adhesion-promoting layer between intermediate layer 2 and reflective layer 6: TiO₂

Barrier layer 8: none

Reflective layer 6: Silver

Lower dielectric layer 5: Al₂O₃

Upper dielectric layer 4: Nb₂O₅

The dielectric layers 4, 5 located above the intermediate layer 2, were applied by electron beam evaporation coating.

After 72 hours, the decrease ΔR in reflectivity amounted to more than 4%. The test was not passed.

### Comparison Example 2 (Miro® Silver, Reference Symbol V2 in FIG. 2)

Layer system (from bottom to top):

Substrate 1: Aluminum

Intermediate layer 2: Anodized aluminum

Adhesion-promoting layer between intermediate layer 2 and reflective layer 6: TiO₂

Barrier layer 8: none

Reflective layer 6: Silver

Lower dielectric layer 5: Al₂O₃

Upper dielectric layer 4: TiO₂

The dielectric layers 4, 5 located above the intermediate layer 2, were applied by electron beam evaporation coating.

After 336 hours the decrease ΔR in reflectivity amounted to more than 1%. The test was not passed.

### Comparison Example 3 (Reference Symbol V3 in FIG. 2)

Layer system (from bottom to top):

Substrate 1: Aluminum

Intermediate layer 2: Anodized aluminum

Adhesion-promoting layer between intermediate layer 2 and reflective layer 6: TiO₂

Barrier layer 8: none

Reflective layer 6: Silver

Lower dielectric layer 5: SiO₂

Upper dielectric layer 4: TiO₂

The dielectric layers 4, 5 located above the intermediate layer 2, were applied by electron beam evaporation coating.

After 336 hours the decrease ΔR in reflectivity amounted to more than 1%. The test was not passed.

### Example 1 (According to Invention, Reference Symbol B1 in FIG. 2)

Layer system (from bottom to top):

Substrate 1: Aluminum

Intermediate layer 2: Anodized aluminum

Barrier layer 8: metallic chromium

Adhesion-promoting layer 9 between barrier layer 8 and reflective layer 6: TiO₂

Reflective layer 6: Silver

Lower dielectric layer 5: Al₂O₃

Upper dielectric layer 4: Nb₂O₅

The lower dielectric Al₂O₃-layer 5 located over the intermediate layer 2 was applied by electron beam evaporation coating, whereas the upper dielectric Nb₂O₅-layer 4 was applied by magnetron sputter coating.

After 1000 hours the decrease ΔR in reflectivity amounted to less than 1%. The test was passed.

### Example 2 (According to the Invention, Reference Symbol B2 in FIG. 2)

Layer system (from bottom to top):

Substrate 1: Aluminum

Intermediate layer 2: Anodized aluminum

Barrier layer 8: metallic chromium

Adhesion-promoting layer 9 between barrier layer 8 and reflective layer 6: TiO₂

Reflective layer 6: Silver

Lower dielectric layer 5: Al₂O₃

Upper dielectric layer 4: TiO₂

The lower dielectric Al₂O₃-layer 5 above the intermediate layer 2 was applied by electron beam evaporation coating, whereas the upper dielectric TiO₂-layer 4 was applied by magnetron sputter coating.

After 1000 hours the decrease ΔR in reflectivity amounted to less than 1%. The test was passed.

### Example 3 (According to the Invention; Reference Symbol B3 in FIG. 2)

Layer system (from bottom to top):

Substrate 1: Aluminum

Intermediate layer 2: Anodized aluminum

Barrier layer 8: metallic chromium

Adhesion-promoting layer 9 between barrier layer 8 and reflective layer 6: TiO₂

Reflective layer 6: Silver

Lower dielectric layer 5: SiO₂

Upper dielectric layer 4: Nb₂O₅

The lower dielectric SiO₂-layer 5 above the intermediate layer 2 was applied by plasma-enhanced chemical vapor deposition (PE-CVD), whereas the upper dielectric Nb₂O₅-layer 4 was applied by magnetron sputter coating.

After 1000 hours the decrease ΔR in reflectivity amounted to less than 1%. The test was passed.

### Example 4 (According to Invention, Reference Symbol B4 in FIG. 2)

Layer system (from bottom to top):

Substrate 1: Aluminum

Intermediate layer 2: Anodized aluminum

Barrier layer 8: metallic Ni₈₀Cr₂₀ (80:20 percent by weight)

Adhesion-promoting layer 9 between barrier layer 8 and reflective layer 6: TiO₂

Reflective layer 6: Silver

Adhesion-promoting layer 10 between reflective layer 6 and dielectric layer 5 CrOₛ

Lower dielectric layer 5: Al₂O₃

Upper dielectric layer 4: Nb₂O₅

The lower dielectric Al₂O₃-layer 5 disposed over the intermediate layer 2 was applied by electron beam evaporation coating, whereas the upper dielectric Nb₂O₅-layer 4 was applied by magnetron sputter coating.

After 1000 hours, the decrease ΔR in reflectivity amounted to less than 1%. The test was passed.

### Example 5 (According to Invention, Reference Symbol B5 in FIG. 2)

Layer system (from bottom to top):

Substrate 1: Aluminum

Intermediate layer 2: Anodized aluminum

Barrier layer 8: metallic Ni₈₀Cr₂₀ (80:20 percent by weight)

Adhesion-promoting layer 9 between barrier layer 8 and reflective layer 6: TiO₂

Reflective layer 6: Silver

Adhesion-promoting layer 10 between reflective layer 6 and dielectric layer 5 CrOₛ

Lower dielectric layer 5: Al₂O₃

Upper dielectric layer 4: TiO₂

Covering layer 9: SiO₂ with carbon content of 1%

The covering layer 9 applied above the optical multi-layer system 3 was applied by a PE-CVD method.

After 1000 hours, the decrease ΔR in reflectivity amounted to less than 1%. The test was passed.

The person skilled in the art can supplement the invention through additional favorable measures, without thereby departing from the scope of the invention. For example; as is likewise indicated in the illustration; an additional decorative layer 12 can be applied onto the side B facing away from the optical multi-layer system 3, in particular on the substrate 1, which can also optionally have an anodically oxidized layer 11 on this side. This decorative layer 12 can be, for example, a metallic reflective layer or one made of titanium nitride or other suitable materials, which can lend the layer a sheen and also a particular coloration. This is an advantage in particular when reflector elements for lighting are to be produced from the composite material V according to the invention.

Another preferred application is the placement of LED lighting sources, e.g. in the form of chips, onto the surface of the invented composite material V. With regard to the additional possible details, the reader is referred to the document DE 10 2012 108 719 A1 in its entirely, for example.

Finally, owing to its long-term stability and high total light reflection, the composite material V according to the invention has outstanding suitability for use in solar facilities which are installed in greenhouses and concentrate sunlight into heat energy, as is described in U.S. Pat. No. 8,915,244 B2, for example. Here too, the reader is referred to the referenced document in its entirety for a description of additional possible details.

Not only can a pair of upper dielectric and/or oxidic layers 4, 5 be disposed in the optical multi-layer system 3 over the reflective layer 6, but rather also several such pairs can be arranged so that the reflectivity of the invented composite material V can be even further enhanced. The optionally provided adhesion-promoting layer 10 can in this case be preferably a constituent on one such layer pair, wherein a layer located above it should display a correspondingly greater refractive index.

While the above description constitutes the preferred embodiment of the present invention, it will be appreciated that the invention is susceptible to modification, variation and change without departing from the proper scope and fair meaning of the accompanying claims.

1. A reflective composite material comprising, a substrate comprising of aluminum, with an intermediate layer of an anodic oxidized substrate material located on one side of the substrate, and with an optically active multi-layer system applied above the intermediate layer, wherein the multi-layer system consists of at least three layers including a first upper layer, a second upper layer and a bottom layer, and wherein the first and second upper layers are dielectric or oxidic layers, and the bottom layer is a reflective layer consisting essentially of silver, a diffusion-inhibiting barrier layer is disposed between the intermediate layer and the reflective layer, wherein the reflective layer is bonded to the barrier layer by an adhesion-promoting layer.

2. A composite material according to claim 1, further comprising, the barrier layer is a metallic or a nitride layer.

3. A composite material according to claim 1, further comprising, the barrier layer consists essentially or entirely of metallic chromium or nickel or a chromium-nickel alloy or palladium.

4. A composite material according to claim 1, comprising, the barrier layer contains a material of the chemical composition CrwNixNyOz, wherein the indices w, x, y and z denote a stoichiometric or non-stoichiometric ratio.

5. A composite material according to claim 4, further comprising, the stoichiometric or non-stoichiometric ratio of the barrier layer w, x, y, z is governed as follows: 0≤w≤1 and 0≤x≤1, wherein at least one of the indices w or x is greater than zero, and 0≤y≤1, 0≤z≤5.

6. A composite material according to claim 1, further comprising, the barrier layer has a thickness in the range from 5 nm to 500 nm.

7. A composite material according to claim 1, further comprising, the first upper layer of the optical multi-layer system is a higher refractive layer than the second upper layer of the optical multi-layer system, wherein the first upper layer consists essentially of Ta₂O₅, Nb₂O₅, MoO₃, TiO₂ or ZrO₂, and the second upper layer consists essentially of Al₂O₃ or SiO₂.

8. A composite material according to claim 1, further comprising, an additional adhesion-promoting layer is disposed between the or second upper layer of the optical multi-layer system and the reflective layer.

9. A composite material according to claim 1, further comprising, the adhesion promoting layer is an oxidic layer.

10. A composite material according to claim 1, further comprising, the adhesion-promoting layer is formed essentially from Al₂O₃, TiO₂ or CrOₛ, wherein s denotes a stoichiometric or non-stoichiometric ratio and is in the range of 0<s<1.5.

11. A composite material according to claim 8, further comprising, the adhesion promoting layer and the additional adhesion-promoting layer each have a thickness in the range from 0.1 nm to 50 nm, wherein for the adhesion-promoting layer between the barrier layer and the reflective layer has a thickness in the range from 5 nm to 25 nm and the additional adhesion-promoting layer between the reflective layer and the bottom dielectric or oxidic layer of the optical multi-layer system, a thickness in the range from 0.1 nm to 10 nm.

12. A composite material according to claim 1, further comprising, the thickness of the reflective layer is in the range from 30 nm to 200 nm.

13. A composite material according to claim 1, further comprising, a silicon oxidic or silicon nitridic covering layer is applied onto the multi-layer system.

14. A composite material according to claim 1, further comprising, a mixed layer having the chemical composition SiaCbOcNdHe is applied onto the optical multi-layer system as a covering layer, as a CVD-layer, or a PE-CVD layer, wherein the indices a, b, c, d, and e denote a stoichiometric or non-stoichiometric ratio and are adjusted such that the covering layer at a selected layer thickness has only a minor light absorption, having a light absorption of less than 10 percent, and wherein the carbon content relative to the total mass of the covering layer is in the range from 0.2 atom-percent, to 15.0 atom-percent.

15. A composite material according to claim 1, further comprising, a silicon-organic lacquer layer based on a sol-gel layer, with a layer thickness in the range from 0.5 μm to 5 μm is applied as a covering layer onto the optical multi-layer system.

16. A composite material according to claim 1, further comprising, the first and second upper layers of the optical multi-layer system each has a thickness in the range from 30 nm to 200 nm.

17. A composite material according to claim 1, further comprising, the first and second upper layers of the optical multi-layer system each has a thickness which amounts to one-fourth of the average wavelength of the spectral range of the electromagnetic radiation to be reflected.

18. A composite material according to claim 1, further comprising, the intermediate layer has a thickness in the range from 10 nm to 10.0 μm.

19. A composite material (V) according to claim 1, further comprising, the surface of the intermediate layer has an arithmetic average roughness value of less than 0.05 μm.

20. A composite material according to claim 1, further comprising, pores in the intermediate layer are sealed by a hot sealing applied using steam.

21. A composite material according to claim 1, further comprising, one or a plurality of the first and second upper layers, the bottom layer, the barrier layer and the adhesion-promoting layers are sputter layers, or layers produced by reactive sputtering, CVD or PECVD layers or by vapor coating, or by electron bombardment or layers produced from thermal sources.

22. A composite material according to claim 1, further comprising, at least two of the layers including the first and second upper layers, the bottom layer, the barrier layer and the adhesion-promoting layer arranged over the intermediate layer are layers applied in a vacuum sequence in a continuous process.

23. A composite material according to claim 1, further comprising, the aluminum of the substrate has a purity greater than 99.0%.

24. A composite material according claim 1, further comprising, the composite material is formed as a coil with a width up to 1600 mm.

25. A composite material according to claim 1, further comprising, a total light reflectivity on side of the optical multi-layer system determined according to DIN 5036, Part 3, is greater than 97%.

26. A composite material according to claim 1, further comprising, in a wipe test corresponding to DIN ISO 9211-4:2012, wherein instead of a cheesecloth, a felt cloth is used, no damage to the surface of the composite material is visible after at least 100 wiping passes.

27. A composite material according to claim 1, further comprising, in a test corresponding to DIN ISO 9211-4:2006 or ASTM D4585, after at least 168 h load cycles at elevated temperature, no optical change to the surface of the composite material occurs, or a decrease in total light reflection of less than 1% for LED applications as per DIN 5036-3 or a decrease in the solar weighted total reflection of less than 1% for solar applications with the solar spectrum AM1.5 from ASTM G173-03 occurs.

28. A composite material according to claim 1, further comprising, in a test with a solar simulator as per ASTM E-927-85 “Type Class A” at a measured UV-A and UV-B total intensity on the sample surface, which has a temperature of at least 150° C., the decrease in total light reflection Y or the solar weighted total reflection Rₛₒₗₐᵣ is less than 1%, wherein the exposure time to reach this change in reflection in the case of a total UV intensity of 150 mW/cm², amounts to at least 500 h, and in the case of a total UV intensity of 70 mw/cm², amounts to at least 1000 h.
